(19) United States
(12) Patent Application Publication
(10) Pub. No.: US 2003/0012950 A1
(43) Pub. Date: Jan. 16, 2003

(54) Powder coating dispersions comprising effect pigments

(75) Inventors: Manfred Kieser, Darmstadt (DE); Alfred Hennemann, Brombachtal (DE)

Correspondence Address: MILLEN, WHITE, ZELANO & BRANIGAN, P.C., 2200 CLARENDON BLVD., SUITE 1400, ARLINGTON, VA, 22201, US

(73) Assignee: Merck Patent GmbH, Darmstadt (DE)

(21) Appl. No.: 10/174,509

(22) Filed: Jun. 19, 2002

(30) Foreign Application Priority Data
Jun. 19, 2001 (DE) 101 29 506.5

(51) Int. Cl. D02G 3/00; C04B 33/32; B28B 5/00

(52) U.S. Cl. 428/396; 428/397; 264/115; 264/678

(57) ABSTRACT

The present invention relates to aqueous powder coating dispersions which comprise from 5 to 60% by weight of powder coating, from 0.2 to 10% by weight of effect pigment and, if desired, further surface-coating auxiliaries. The invention also relates to the preparation of the aqueous powder coating dispersions and to their use.

The present invention relates to aqueous powder coating dispersions which comprise effect pigments, in particular platelet-shaped effect pigments, such as, for example, luster pigments. The present invention furthermore relates to the preparation and use of dispersions of this type.

On use of effect pigments in powder coatings, in particular on use of platelet-shaped effect pigments in powder coatings, two main problems occur which depend on the point in time at which the pigment is admixed with the powder coating.

Thus, the luster pigments can basically be added to the powder coating either before or after extrusion and grinding processes. If the effect pigments are added before an extrusion and grinding step, this may, in the worst case, depending on the pigment nature, result in complete destruction of the pigment structure and thus in undesired pigment properties. This becomes particularly clear if all powder coating components and a platelet-shaped effect pigment (luster pigment) are extruded and ground together, since the pigment is so badly damaged in the finished powder coating that, for example, the optical luster effect is virtually completely lost.

In the case of subsequent addition (dry blending) of effect pigments, in particular metal-effect or pearlescent pigments, however, an increase or reduction in the amount of effect pigments on the object to be coated is observed—depending on the powder coating and pigment. The cause of this is, inter alia, the different charging behavior of the powder coating and pigment particles. The optical properties (for example luster, color and hiding power) of objects coated with fresh material therefore differ very significantly from those which have been coated with re-used overspray material. However, the re-use of overspray occasionally also causes problems in connection with a large amount of original material.

Various processes have been described for solving the separation problem. Thus, one process is based on the introduction of mechanical and possibly thermal energy into the effect pigment/powder coating system, causing mechanical connection of powder coating and effect pigment and enabling separation to be prevented.

DE-A 24 34 855 thus describes, for example, the preparation of metal-pigmented plastic powder in a very complex plant. In this process, the pigment platelets are fixed to the surface of the powder coating particles by a brushing process.

DE-A 44 41 638 A1 describes a significantly simpler plant for the production of luster-pigmented powder coatings in which powder coatings with particularly good free-flow properties for electrostatic application are obtained.

DE 44 43 048 discloses a completely different problem solution regarding the avoidance of separation processes during powder coating application. According to this specification, the effect powder coating must comprise, as an essential constituent, from 0.1 to 10% by weight of conductive pigments, where the pigmented powder coating itself must not be conductive.

DE-A 196 18 657 discloses aqueous, non-pigmented powder coating dispersions for automobile painting which are preferably subjected to wet grinding.

The present invention provides a powder coating/effect pigment mixture which is advantageous compared with the disadvantages of the prior art. In particular, the powder coating/effect pigment mixture should neither exhibit the above separation problems nor have the disadvantages of mixtures which have been subjected to grinding and extrusion processes. Furthermore, the production process should be greatly simplified and the range of powder coatings and pigments which can be employed should be increased.

Surprisingly, these objects have been achieved by the provision of an aqueous powder coating/effect pigment dispersion which comprises water from 5 to 60% by weight of powder coating and from 0.2 to 10% by weight of effect pigment. A powder coating proportion of from 10 to 40% by weight and an effect pigment proportion of from 1 to 8% by weight, more preferably from 1.5 to 6% by weight, are preferred. The weight % being based on the total weight of the dispersion.

All conventional pigmented or unpigmented powder coating materials can be employed in the aqueous powder coating dispersions according to the invention. Mixtures of different powder coatings having different colors, surface effects or different chemical structure can also be used. For example, polyester, epoxy/polyester, epoxy, polyurethane or acrylate powder coatings may be mentioned. Examples of powder coating materials include those described in Ullman's Encyclopedia of Industrial Chemistry, Paints and Coatings, Chapter 3.4, Coating Powders and, Chapter 7.2.3, Powder Coatings.

The particle sizes of the powder coating can vary greatly here and are not restricted to the conventional particle size ranges for powder coatings (from 20 to 150 μm); thus, for example, powder coating particle sizes of from 10 to 50 μm or less are readily possible since the fine grinding of the powder coating can also be carried out in the aqueous phase.

The only restriction with respect to the powder coatings is that they must be sufficiently stable to the aqueous, homogeneous phase of the dispersion.

There are likewise no restrictions regarding the effect pigments; on the contrary, pigments which cannot be employed in conventional powder coatings are also suitable, such as, for example, those which would usually be destroyed in the case of excessive mechanical loading, such as extrusion and grinding steps. These include, in particular, effect pigments and very particularly platelet-shaped effect pigments, such as, for example, luster pigments. Merely by way of example, mention may be made of the following pigment types, such as metal-effect pigments, pearlescent pigments and interference pigments. Some preferred non-limiting examples of effect pigments are coated or uncoated metal platelets, for example aluminum pigments, pearlescent pigments based on natural or synthetic mica platelets, glass flakes, Al₂O₃ flakes, SiO₂ flakes, Fe₂O₃ flakes, graphite flakes, holographic pigments and multilayer pigments.

On the other hand, however, it must be ensured that the pigments also remain stable in the aqueous powder coating dispersion.

In order to obtain stable dispersions of powder coating and pigment which have good storage and processing properties, the dispersions may additionally comprise water-soluble and/or water-dispersible additives, i.e. additives which are conventional in surface coatings, such as, for example, surface-active substances, thickeners, flow-control agents or other auxiliaries. Additives of this type include, for example, the substances mentioned in DE 196 18 657 and those mentioned in “Lackrohstoff-tabellen” [Coating Raw Materials Tables] (10th Edition, Vincent Verlag). Surface-active substances which may be employed are, for example, ionic or nonionic surfactants. Typical thickeners are, for example, polyacrylates, polyurethanes, cellulose derivatives and inorganic gel formers. Flow-control agents which can be employed are, for example, silicones, acrylates and a number of further substances of different chemical structure, and suitable other auxiliaries are, for example, antisettling agents, antistatics, catalysts and preservatives. However, the choice is in no way restricted to the above lists, and selection and metering are readily possible for the person skilled in the art depending on the requirements of the type of application.

The process according to the invention for the production of aqueous powder coatings comprises mixing of water, powder coating and pigment and, if desired, additives which are conventional in surface coatings, as described above, in any desired sequence, with the fine grinding of the powder coating in aqueous dispersion preferably being carried out before the addition of the effect pigment.

The processing of the dispersion, i.e. the coating of substrates, can be carried out by spraying, brushing, dipping, rolling or by other methods which are usual for wet coatings. Preference is given here to spraying, either with air, without air or electrostatically using the usual devices. On use of these application techniques, the person skilled in the art only need take note of the applicational properties of the powder coating dispersion which would be known and are necessary for the particular application technique.

The aqueous pigmented powder coating dispersions can be employed, for example, in automobile painting (initial painting and refinish painting), but also in industrial coatings and in many areas of general surface coating.

The entire disclosure[s] of all applications, patents and publications, cited above or below, and of corresponding German application No. 10129506.5, filed Jun. 19, 2001, is hereby incorporated by reference.

### EXAMPLES

In the foregoing and in the following examples, all temperatures are set forth uncorrected in degrees Celsius; and, unless otherwise indicated, all parts and percentages are by weight.

Preparation Examples

### Example 1

4 g of a titanium dioxide/mica pearlescent pigment (Iriodin® 103) and 36 g of a commercially available clear powder coating (Teodur 00013 clear; Herberts) are stirred into 58.9 g of demineralized water to which 0.2 g of a nonionic surfactant (polyoxy-ethylenesorbitan trioleate, Tween 85; Merck; Art. No. 8.22188) and 0.9 g of poly(meth)acrylic acid dispersion (Rohagit SD 15; Polymer Latex GmbH) have been added, and distributed homogeneously. After the pH has been set to a value of 9, for example using ammonia, the powder coating dispersion is ready to process. The processing is carried out by airless spraying. After drying and baking, a homogeneous coating film which, according to analysis, has the same effect pigment content (10% by weight) as the dry “starting powder coating” (pigment plus powder coating), is obtained. The visually perceptible luster effect achieved is very good. The effect pigment is not damaged.

### Example 2

2 g of an Fe₂O₃/mica pearlescent pigment (Iriodin® 504) and 38 g of a commercially available clear powder coating (Teodur 00013 clear; Herberts) are stirred into 58.7 g of demineralized water to which 0.1 g of a nonionic surfactant (polyoxyethylene-sorbitan trioleate, Tween 85; Merck; Art. No. 8.22188) and 1.2 g of a polymer thickener (Collacral VL, BASF AG) have been added, and distributed homogeneously. The processing is carried out by airless spraying. After drying and baking, a homogeneous coating film which, according to analysis, has the same effect pigment content (5% by weight) as the dry “starting powder coating” (pigment plus powder coating), is obtained. The luster effect is excellent since the pigment is in undamaged form in the coating film.

### Example 3

1 g of a titanium dioxide/mica pearlescent pigment (Iriodin® 153) and 39 g of a commercially available grey powder coating (Interpon 200 grey, International Powdercoat) are stirred into 58.5 g of demineralized water to which 0.2 g of a non-ionic surfactant (polyoxyethylenesorbitan trioleate, Tween 85; Merck; Art. No. 8.22188) and 1.3 g of a polyacrylic acid dispersion (Rohagit SL 606; Röhm GmbH) have been added, and distributed homogeneously. The processing is carried out by dipping. After drying and baking, a homogeneous coating film which, according to analysis, has the same effect pigment content (2.5% by weight; the proportion of the pigments/fillers present in the grey powder coating was subtracted) as the dry “starting powder coating” (pigment plus powder coating), is obtained. The luster effect is excellent since the pigment is in undamaged form in the coating film.

The preceding examples can be repeated with similar success by substituting the generically or specifically described reactants and/or operating conditions of this invention for those used in the preceding examples.

From the foregoing description, one skilled in the art can easily ascertain the essential characteristics of this invention and, without departing from the spirit and scope thereof, can make various changes and modifications of the invention to adapt it to various usages and conditions.

1. An aqueous powder coating dispersion, which comprises water, from 5 to 60% by weight of a powder coating material and from 0.2 to 10% by weight of an effect pigment.

2. An aqueous powder coating dispersion according to claim 1, which comprises from 10 to 40% by weight of the powder coating material and from 1 to 8% by weight of the effect pigment.

3. An aqueous powder coating dispersion according to claim 1 wherein the effect pigment is a platelet-shaped effect pigment.

4. An aqueous powder coating dispersion according to claim 2 wherein the effect pigment is a platelet-shaped effect pigment.

5. An aqueous powder coating dispersion according to claim 3, wherein the platelet-shaped effect pigment is a luster pigment.

6. An aqueous powder coating dispersion according to claim 4, wherein the platelet-shaped effect pigment is a luster pigment.

7. An aqueous powder coating dispersion according to claim 1 which additionally comprises one or more of a surface-active substance, thickener or flow-control agent.

8. A process for preparing an aqueous powder coating dispersion according to claim 1 which comprises mixing water, the powder coating material and the effect pigment.

9. The process according to claim 8, the powder coating material in aqueous dispersion is finely ground before being mixed with the effect pigment.

10. A method for providing a coating on a substrate which comprises applying an aqueous powder coating dispersion of claim 1 onto the substrate and drying it.

11. The method of claim 10, wherein the dispersion is applied to the substrate by spraying, brushing, dipping or rolling.

12. The method of claim 10, wherein the dispersion is applied by spraying.

13. The method of claim 10, wherein the substrate is an automobile part.
